(19) United States
(12) Patent Application Publication
(10) Pub. No.: US 2010/0280897 A1
(43) Pub. Date: Nov. 4, 2010

(54) METHOD AND SYSTEM FOR PROVIDING A CONTENT-ON-DEMAND SERVICE

(75) Inventors: Gabriele Elia, Torino (IT); Stefania Lisa, Torino (IT); Giuseppe Piersantelli, Torino (IT)

Correspondence Address: BANNER & WITCOFF, LTD., 1100 13th STREET, N.W., SUITE 1200, WASHINGTON, DC, 20005-4051, US

(73) Assignee: TELECOM ITALIA S.P.A., Milano (IT)

(21) Appl. No.: 12/809,756

(22) PCT Filed: Dec. 20, 2007
(86) PCT No.: PCT/EP2007/064294

§ 371 Date: Jun. 21, 2010

(51) Int. Cl. G06Q 30/00

(52) U.S. Cl. 705/14.31; 705/14.41

(57) ABSTRACT

It is disclosed a method of providing a content-on-demand service to a user by a communication network. The method includes transmitting content to a first terminal of the user and determining whether the user wishes to pay for the content at a reduced price. In the affirmative, the method further includes: generating an acknowledge request message and an expected acknowledge message; generating an advertising block including k commercials and the acknowledge request message in such a way that the user is able to answer the acknowledge request message after consuming the k commercials; transmitting the advertising block to a second terminal of the user; listening for an acknowledge message from the second terminal; and determining whether the received acknowledge message corresponds to the expected acknowledge message.

### TECHNICAL FIELD

The present invention relates to the field of content-on-demand services. In particular, the present invention relates to a method and a system for providing a content-on-demand service to a user by means of a communication network.

### BACKGROUND ART

It is known that a content-on-demand service allows a user to purchase a content from a content provider and to enjoy the content on a terminal of his choice.

The content may be either an audio content such as a song, or a multimedia content such as a movie, a clip or a live coverage of an event (e.g. a football match or a concert). If the content is an audio content, the terminal for enjoying it may be for instance a mobile phone, an mp3-player, or a computer provided with an application for reading audio files and with audio means for playing them. Besides, if the content is a multimedia content, the terminal for enjoying it may be a mobile phone, a computer provided with an application for reading multimedia files and with video/audio means for playing them, or a decoder or a set-top box connected to a television.

Typically, the terminal is connected to the content provider by means of a broadband connection (e.g. an ADSL line, a fiber optic line, a satellite link) through which the content provider transmits the content to the terminal in a digital format.

When a user purchases a content, the purchased content may be provided to such a user according to different mechanisms.

According to a first mechanism, which is used for instance by the known “video-on-demand” services (or, briefly, VOD services), the content provider transmits a content only to the terminal of the user who purchased it, as soon as the purchase operation has been completed (e.g. when the user has paid the content). The content may be transmitted either by a streaming operation or by a download operation. In case of streaming, the user enjoys the content as its terminal receives it. In case of download, the content may be stored on the terminal, and then the user may enjoy it whenever he wants.

According to a second mechanism, which is used for instance by the known “near video-on-demand” services, the content provider starts broadcasting a content (e.g. by means of a satellite) at a predetermined time. Accordingly, all the terminals connected to the satellite receive the content, but only when a user purchases the content its terminal is enabled to play the content. In such services, the content provider preferably broadcasts a same content in parallel on different channels, the broadcasting of the content on each channel being started at different times. In this way, when a user decides to purchase the content, a broadcasting is likely to start within a short time, so that he can enjoy the content from the start without waiting for a too long time.

A user purchasing a content may pay it in different ways. For instance, a user may buy a prepaid card to be inserted in a suitable slot of the terminal for enabling it to receive and play the purchased contents. The price of each purchased content is then deducted from the credit of the prepaid card. As an alternative, if the content provider is also the telephone service provider of the user, the price of each purchased content may be charged to the telephone bill of the user. As an alternative, payment may be performed by a credit card.

A user may also pay a purchased content by agreeing to receive commercials.

U.S. Pat. No. 6,950,804 discloses a method of delivering content from a content delivery system to a user's terminal over a communication link. The method comprises: (a) receiving a request from a user of the content delivery system to download a content item to the user's terminal over the communications link; (b) checking the status of the content item relative to the user in order to determine if access to the content item by the user is free; (c) in response to the status check, providing at least two payment options to the user if the results of the status check indicate that access to the content item is not free for the user, one of the payment options being the option to receive advertising with the content item in lieu of paying money to receive the content item; (d) receiving a payment option selection from the user; (e) preparing the content item for download in accordance with the selected payment option, wherein preparation of the content item for downloading includes appending a targeted advertisement to the content item when the user selects to receive advertising as the payment option; and (f) downloading the prepared content item from the content delivery system to the user's terminal over the communications link.

U.S. Pat. No. 6,505,169 discloses, in a multimedia presentation transmitted by streaming media, to dynamically insert advertising/announcements into the stream in response to a realization of conditions preselected by the presenter of the streaming media content and by the source of the advertising/announcements. In a particular embodiment providers of the streaming media content define metadata describing the programming stream structure. Advertising/announcement sources define metadata describing categories of desired recipients of their ads. The requirements of both metadata files are compared with respect to both content data and ad data to specify conditions to determine which advertisement/announcement is inserted into a media stream and when that insertion occurs.

U.S. Pat. No. 6,026,368 discloses to generate prioritized queues of advertising and content data by a queue builder and to send to an on-line queue manager. A computer mediated communications network provides content and subscriber data to the queue builder and receives content segment play lists from the on-line queue manager. An exposure accounting module calculates and stores information about the number of exposures of targeted material received by subscribers and generates billing information. An information warehouse manager is employed to receive data from advertisers' data bases and third party sources as well as from the computer mediated communications network.

### SUMMARY OF THE INVENTION

The Applicant has noticed that the above known solutions have some drawbacks.

Indeed, the solutions disclosed by U.S. Pat. No. 6,950,804 and U.S. Pat. No. 6,505,169 disadvantageously force the user to periodically stop enjoying the purchased content due to the commercials breaks. Further, they disadvantageously do not allow the content provider to check whether the user has actually consumed (i.e. viewed, or read, or listened to, according to the commercial format) the commercials. Indeed, even if the commercials are inserted within the purchased content, the content provider may not check whether the user has avoided consuming the commercials e.g. by moving away from the terminal during the commercial breaks.

Besides, disadvantageously, according to the solution disclosed by U.S. Pat. No. 6,950,804, checking whether the user has actually consumed the commercials is even more difficult, since the user may choose to receive the commercials on a terminal different from the one he uses for enjoying the content.

Accordingly, the Applicant has tackled the problem of providing a method and a system for providing a content-on-demand service, which allows the user to enjoy the content without commercial breaks, while allowing the content provider to check whether the user has actually consumed the commercial.

According to a first aspect, the present invention provides a method of providing a content-on-demand service to a user by means of a communication network, wherein the method comprises: transmitting a content to a first terminal of the user; generating an acknowledge request message and an expected acknowledge message; generating an advertising block including k commercials and the acknowledge request message in such a way that the user is able to answer to the acknowledge request message only after consuming the k commercials, wherein k is an integer number equal to or higher than 1; transmitting the advertising block to a second terminal of the user; listening for an acknowledge message from the second terminal; and determining whether the received acknowledge message corresponds to the expected acknowledge message.

Preferably, the method further comprises charging the user with a reduced price for the content, if during the step of determining it is determined that the received acknowledge message corresponds to the expected acknowledge message.

Preferably, before the step of transmitting the advertising block, the method comprises a step of receiving from the user an information indicating whether the second terminal and the first terminal are a same terminal or different terminals. Preferably, after the step of transmitting the advertising block, the method comprises a step of consuming the k commercials by means of the second terminal during a given time period, the given time period being not superimposed with a further time period in which the user enjoys the content by means of the first terminal.

Preferably, before the step of listening for an acknowledge message, the method comprises a step of determining a maximum delay Tmax within which the user has to consume the k commercials.

Preferably, the step of listening for an acknowledge message is performed until the maximum delay Tmax expires.

Profitably, the method further comprises a step of, if during the step of listening the acknowledge message is not received before the maximum delay Tmax expires, charging the user with a full price of the content.

Preferably, the step of generating an advertising block comprises a step of selecting the k commercials such that an overall value of the k commercials is about equal to a difference between the full price and the reduced price.

Preferably, the step of generating an advertising block comprises a step of selecting the k commercials according to a content type of the content.

Profitably, after the step of generating an advertising block, the method comprises a step of sending to the second terminal a link to the advertising block, the step of transmitting the advertising block being triggered by the user by selecting the link on the second terminal.

Preferably, the step of transmitting the advertising block further comprises a step of deactivating at least one of a “skip” command and a “fast forward” command at the second terminal and/or a step of keeping a “rewind” command active at the second terminal.

Preferably, the acknowledge request message is generated in the form of an alphanumeric code, and the expected acknowledge message is also generated in the form of the alphanumeric code.

Preferably, the step of generating an advertising block comprises a step of distributing the acknowledge request message in the k commercials.

Preferably, the step of generating an advertising block comprises a step of inserting in the advertising block instructions explaining to the user how to reply to the acknowledge request message by means of the acknowledge message. Such instructions preferably comprise a description of how to determine a content of the acknowledge message according to a content of the acknowledge request message and/or a description of how to transmit the acknowledge message to a provider of the content-on-demand service.

Preferably, if the acknowledge message is received and the acknowledge message does not correspond to the expected acknowledge message, the method further comprises a step of sending to the second terminal a message which informs the user that the acknowledge message is not correct, and which asks the user to check the acknowledge request message and to retransmit the acknowledge message.

According to a second aspect, the present invention provides a content-on-demand system for providing a content-on-demand service to a user by means of a communication network, the content-on-demand system comprising a content delivery module configured to transmit a content to a first terminal of the user; a sponsorship manager configured to generate an acknowledge request message and an expected acknowledge message; and an advertising delivery module configured to be activated by the sponsorship manager for generating an advertising block including k commercials and the acknowledge request message in such a way that the user is able to answer to the acknowledge request message only after consuming the k commercials, wherein k is an integer number equal to or higher than 1, and for transmitting the advertising block to a second terminal of the user; the sponsorship manager is configured to listen for an acknowledge message from the second terminal and determine whether the received acknowledge message corresponds to the expected acknowledge message.

Preferably, the content-on-demand system further comprises a billing module, and the sponsorship manager is further configured to instruct the billing module to charge the user with a reduced price of the content, if it determines that the received acknowledge message corresponds to the expected acknowledge message.

Preferably, the sponsorship manager is further configured to determine a maximum delay Tmax within which the user has to consume the k commercials.

Preferably, the sponsorship manager is further configured to listen for the acknowledge message from the second terminal until the maximum delay Tmax expires.

Profitably, the sponsorship manager is further configured to instruct the billing module to charge the user with the full price, if the acknowledge message is not received before the maximum delay Tmax expires.

Preferably, the advertising delivery module is further configured to select the k commercials such that an overall value of the k commercials is about equal to a difference between the full price and the reduced price.

Preferably, the advertising delivery module is further configured to select the k commercials according to a content type of the content.

Preferably, the sponsorship manager is further configured to generate the acknowledge request message in the form of an alphanumeric code, and to generate also the expected acknowledge message in the form of the alphanumeric code.

Profitably, the advertising delivery module is further configured to distribute the acknowledge request message in the k commercials.

Preferably, the advertising delivery module is further configured to insert in the advertising block instructions explaining to the user how to reply to the acknowledge request message by means of the acknowledge message.

Profitably, the sponsorship manager is further configured to, if the acknowledge message is received and the acknowledge message does not correspond to the expected acknowledge message, send to the second terminal a message which informs the user that the acknowledge message is not correct, and which asks the user to check the acknowledge request message and to retransmit the acknowledge message.

### BRIEF DESCRIPTION OF THE DRAWINGS

The present invention will become clearer by reading the following detailed description, given by way of example and not of limitation, to be read with reference to the accompanying drawings, wherein:

FIG. 1 schematically shows a content-on-demand system according to an embodiment of the present invention;

FIG. 2 is a flow chart showing the operation of the content-on-demand system of FIG. 1;

FIG. 3 is a flow chart showing in further detail step 8 of FIG. 2;

FIG. 4 is a flow chart showing in further detail step 10 of FIG. 2;

FIG. 5 schematically shows a commercial table, according to an embodiment of the present invention; and

FIG. 6 schematically shows a user table, according to an embodiment of the present invention.

### DETAILED DESCRIPTION OF PREFERRED EMBODIMENTS OF THE INVENTION

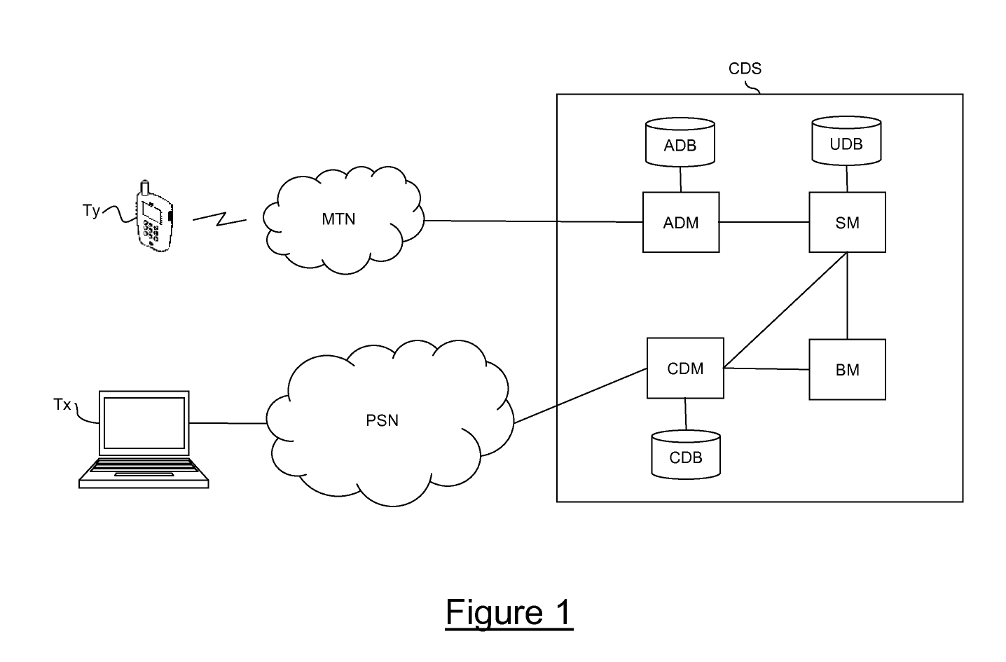

FIG. 1 schematically shows a content-on-demand system CDS according to an embodiment of the present invention.

The content-on-demand system CDS preferably comprises a content delivery module CDM, an advertising delivery module ADM, a billing module BM, a sponsorship manager SM, a content database CDB, an advertising database ADB and a user database UDB.

Preferably, the sponsorship manager SM is configured to cooperate with the user database UDB, the advertising delivery module ADM, the content delivery module CDM and the billing module BM. Further, preferably, the content delivery module CDM is configured to cooperate with the content database CDB, while the advertising delivery module ADM is configured to cooperate with the advertising database ADB.

It is assumed that a user has a first terminal Tx suitable to play a content purchased by the user and received from the content-on-demand system CDS in a digital format. By way of example, the first terminal Tx is a laptop computer. This is merely exemplary since, as mentioned in the introduction, the first terminal Tx may be a mobile phone, an mp3-player, a set-top box connected to a television and so on.

Preferably, the first terminal Tx is connected to the content-on-demand system CDS (and, more particularly, to the content delivery module CDM of the content-on-demand system CDS) by means of a broadband connection. For instance, FIG. 1 shows that the first terminal Tx is connected to the content-on-demand system CDS by means of a packet-switched network PSN, the link between the first terminal Tx and the packet-switched network PSN being implemented e.g. by means of a fiber optic line, an ADSL line, a mobile broadband connection, etc.

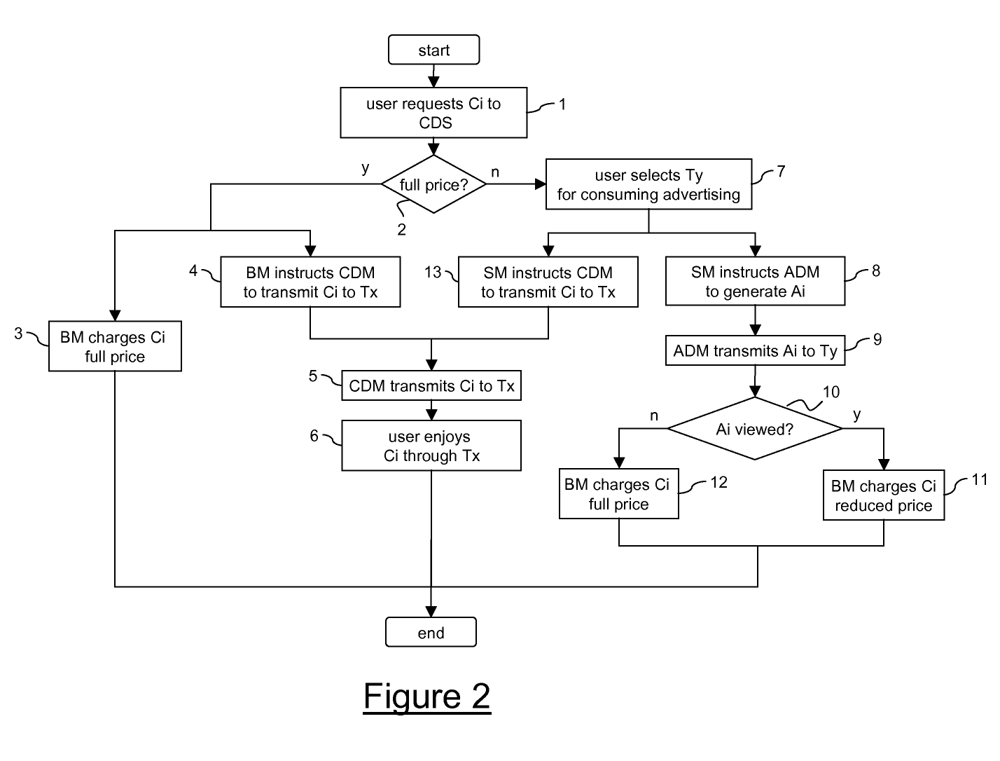

Herein after, by referring to FIG. 2, the operation of the content-on-demand system CDS of FIG. 1 will be described in detail.

It is assumed that the user of the first terminal Tx has subscribed a content-on-demand service offered by a content provider through the content-on-demand system CDS of FIG. 1. The subscription operation will not be described in detail, since it is not relevant to the present description.

During a first step 1, the user sends a content purchase request to the content provider for requesting a content Ci. The content purchase request may be transmitted by means of the first terminal Tx through the packet-switched network PSN to the content-on-demand system CDS. Since it has been assumed that the first terminal Tx is a laptop computer, the content purchase request may be performed for instance by means of a graphic interface displayed by the laptop computer. Alternatively, the content purchase request may be performed by other means, such as by calling a given telephone number of the content provider.

Then, during a step 2, the content provider asks the user whether he wishes to pay the content Ci at its full price or at a reduced price by agreeing to receive a certain number of commercials. The reduced price depends on the discount policy that the content provider has decided to apply to the requested content Ci. The discount policy may also provide that a price reduction of 100% may be applied to the content Ci if the user agrees to receive the commercials, i.e. the content Ci is free. If the content purchase request during step 1 is performed by means of a graphic interface displayed by the laptop computer, step 2 may be performed e.g. by selecting on the graphic interface either a graphical object corresponding to the full price or a graphical object corresponding to the reduced price.

If, during step 2, the user has decided to pay the content Ci at its full price, during step 3 the billing module BM preferably charges the user with the full price of the content Ci. As mentioned above, this step may be performed e.g. by deducting the full price of the content Ci from the credit of a prepaid card, or by charging the full price of the content Ci to the telephone bill of the user, or by charging the full price of the content Ci to the user's credit card.

Substantially at the same time, the billing module BM instructs the content delivery module CDM to deliver the content Ci to the first terminal Tx of the user (step 4).

During step 5, the content delivery module CDM retrieves the content Ci from the content database CDB, which preferably stores all the contents that the content provider can provide on demand to users subscribing its content-on-demand service. The content delivery module Ci then delivers the content Ci to the first terminal Tx of the user by means of the packet-switched network PSN. Content delivery may be performed either according to a streaming mechanism or according to a download mechanism.

Then, during a step 6, the user enjoys the content Ci by means of the first terminal Tx. If, during step 5, the content Ci has been delivered according to a streaming mechanism, steps 5 and 6 are substantially contemporary, since the user enjoys the content as the first terminal Tx receives it from the packet-switched network PSN. On the other hand, if during step 5 the content Ci has been delivered according to a download mechanism, the content Ci is preferably stored on a memory device included in or cooperating with the first terminal Tx (e.g., an hard disk). In this case, step 6 may follow step 5, since the user may enjoy the content Ci whenever he wants after the whole content Ci has been stored in the memory device.

If, during step 2, the user has decided to pay the content Ci at a reduced price and to receive a certain number of commercials, the user may preferably choose a second terminal Ty for receiving the commercials (step 7). If during step 1 the content purchase request is performed by means of a graphic interface displayed by the laptop computer, also step 7 may be performed through the same graphic interface. During step 7, preferably, the user provides an identifier of the second terminal Ty.

The second terminal Ty may coincide with the first terminal Tx, or it may be other than the first terminal Tx. By way of example, in the following description it will be assumed that the second terminal Ty is other than the first terminal Tx. In particular, it is assumed that the second terminal Ty is the user's mobile phone. Therefore, the identifier of the second terminal Ty preferably is the telephone number of the user's mobile phone.

Preferably (by referring again to FIG. 1) also the second terminal Ty is connected to the content-on-demand system CDS, in particular to the advertising delivery module ADM. Since it has been assumed that the second terminal Ty is a mobile phone, FIG. 1 shows that the second terminal Ty is connected to the advertising delivery module ADM by means of a mobile telephone network MTN.

Referring again to FIG. 2, after step 7, the sponsorship manager SM is activated and, during a step 13, it instructs the content delivery module CDM to deliver the content Ci to the first terminal Tx of the user.

Accordingly, the content delivery module CDM performs the above step 5 of retrieving the content Ci from the content database CDB and delivering it to the user's first terminal Tx. Then, the user performs the above step 6 of enjoying the content Ci by means of the first terminal Tx.

Preferably, when step 5 is executed as a consequence of step 13 (i.e. when the content delivery module CDM is instructed by the sponsorship manager SM), during step 5 the content delivery module CDM may insert a message in the content Ci before delivering it, which message reminds the user that he will be charged with the reduced price of the content Ci only if he consumes the commercials he will receive on its second terminal Ty.

When the sponsorship manager SM performs step 13, substantially at the same time it also instructs the advertising delivery module ADM to generate an advertising block Ai including a certain number of commercials (step 8), as it will be described in further detail herein after.

Then, during a step 9, after the advertising delivery module ADM has generated the advertising block Ai according to the instructions imparted by the sponsorship manager SM, it delivers the advertising block Ai to the second terminal Ty through the mobile telephone network MTN. The second terminal Ty then stores the advertising block Ai, so that the user may decide when consuming the commercials included in the advertising block Ai. For instance, by assuming that the commercials are in a video format, the user may decide to view the commercials by means of the second terminal Ty before or after enjoying the content Ci by means of the first terminal Tx.

Alternatively, after generating the advertising block Ai, the advertising delivery module ADM may deliver to the second terminal Ty only a link to the advertising block Ai. Therefore, the second terminal Ty only stores the link. When the user wishes to consume the commercials of the advertising block Ai, he selects the link on its second terminal Ty, thus receiving the commercials of the advertising block Ai. In this case, the commercials of the advertising block Ai may be received either through a streaming mechanism or through a download mechanism.

Optionally, the second terminal Ty may be provided with a function that disables the commands “skip” and “fast forward” while the user is consuming the commercials. This advantageously forces the user to entirely consume the commercials, with no chance to skip any part thereof.

Further, optionally, the second terminal Ty may be provided with a function allowing him to know, while he is consuming a commercial, how many commercials of the advertising block Ai he still has to consume.

Then, after step 9, during a step 10 the sponsorship manager SM checks whether the user has really consumed the commercials of the advertising block Ai, as it will be explained in further detail herein after.

If the sponsorship manager SM determines that the user has actually consumed the commercials of the advertising block Ai, during a step 11 the sponsorship manager SM instructs the billing module BM to charge the user with the reduced price of the content Ci. Similarly to step 3, also step 11 may be performed e.g. by deducting the reduced price of the content Ci from the credit of a prepaid card, or by charging the reduced price of the content Ci to the telephone bill of the user, or by charging the reduced price of the content Ci to the user's credit card. If the discount policy that the content provider applies to the content Ci is such that the price reduction is 100% (i.e. the content Ci is free, provided that the user has consumed the commercials of the advertising block Ai), during step 11 the sponsorship manager SM instructs the billing module SM not to charge any cost to the user.

Otherwise, if during step 10 the sponsorship manager SM determines that the user has not consumed the commercials of the advertising block Ai, during a step 12 the sponsorship manager SM instructs the billing module BM to charge the user with the full price of the content Ci, as explained above by referring to step 3.

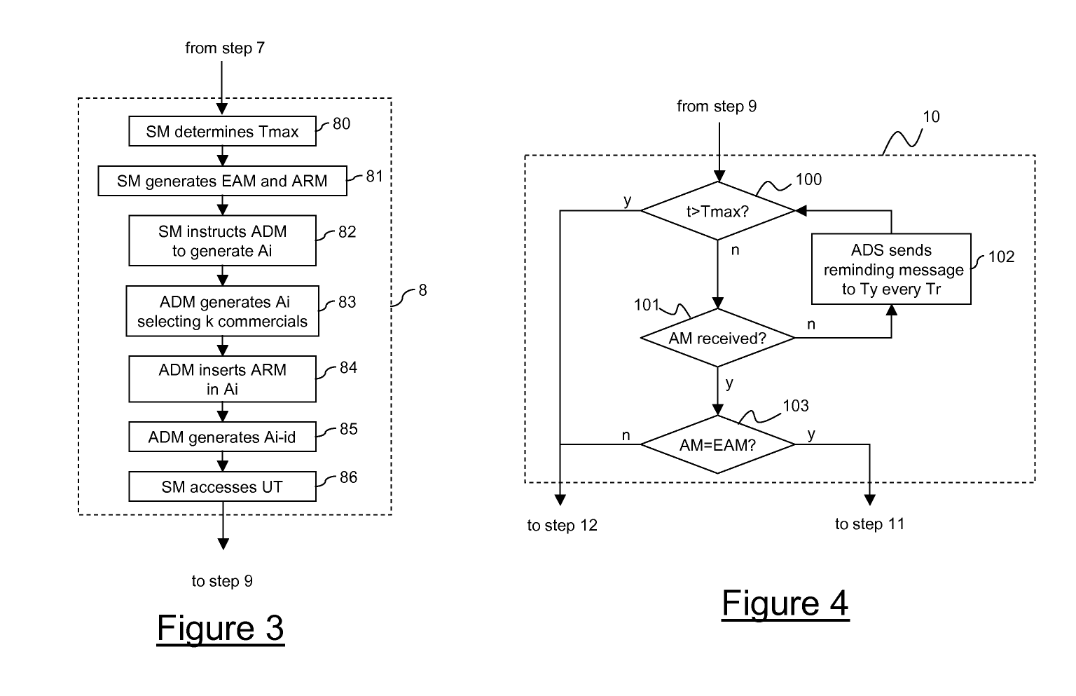

By referring to FIG. 3, step 8 will be now described in further detail.

As described above, during step 8 the sponsorship manager SM instructs the advertising delivery module ADM to deliver an advertising block Ai including a certain number of commercials to the second terminal Ty.

More particularly, during a sub-step 80, the sponsorship manager SM determines a maximum delay Tmax within which the user has to consume the commercials of the advertising block Ai, thus paying the content Ci at the reduced price. Preferably, the maximum delay Tmax depends on the discount policy that the content provider applies to the content Ci. For instance, the maximum delay Tmax may be of some hours or some days.

Then, during a sub-step 81, the sponsorship manager SM preferably generates an acknowledge request message ARM and an expected acknowledge message EAM.

For instance, both the acknowledge request message ARM and the expected acknowledge message EAM may be equal to a same predefined alphanumeric code having a predefined length. Alternatively, the acknowledge request message ARM may be a question regarding one of the commercials of the advertising block Ai (e.g. “which is the product advertised in the last commercial you viewed?”) and the expected acknowledge message EAM may be the correct answer to this question. The roles of the acknowledge request message ARM and the expected acknowledge message EAM will be described in detail herein after.

Even though in FIG. 3 the sub-step 81 is shown as subsequent to the sub-step 80, according to other embodiments not shown in the drawings, the sub-step 81 may be performed before the sub-step 80 or substantially at the same time.

Then, preferably, during a sub-step 82 the sponsorship manager SM instructs the advertising delivery module ADM to generate the advertising block Ai by including in the advertising block Ai a number k of commercials, k being an integer number equal to or higher than 1. Preferably, the k commercials should be chosen such that:

i) the overall value of the k commercials is equal about to the difference between the full price and the reduced price of the content Ci; and
ii) the overall duration of the k commercials is lower than the difference between the maximum delay Tmax and the duration of the content Ci.

The condition ii) about the overall duration of the k commercials advantageously allows the user both to enjoy the content Ci and to consume the k commercials before the maximum delay Tmax expires.

Further, during the sub-step 82, the sponsorship manager SM preferably sends to the advertising delivery module ADM the acknowledge request message ARM generated during the sub-step 81, and it instructs the advertising delivery module ADM to insert also the acknowledge request message ARM in the advertising block Ai.

Then, during a sub-step 83, the advertising delivery module ADM cooperates with the advertising database ADB for retrieving the commercials to be inserted in the advertising block Ai. To this purpose, the advertising delivery module ADS preferably looks up a commercial table CT which is stored in the advertising database ADB.

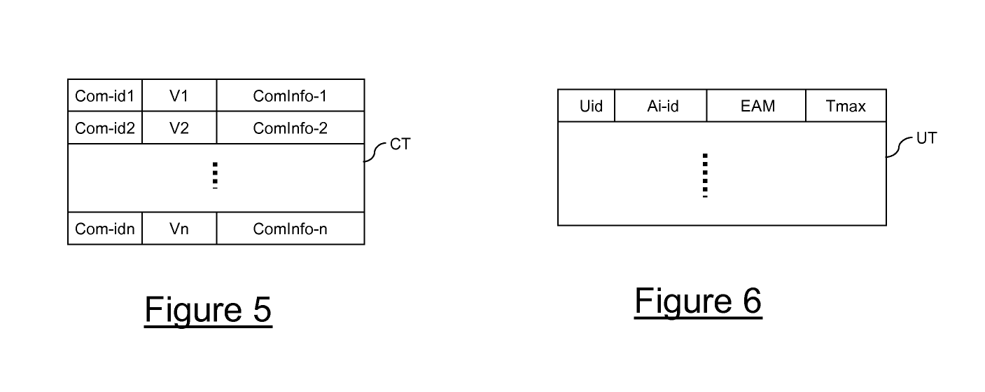

FIG. 5 schematically shows the commercial table CT according to an embodiment of the present invention. Preferably, the commercial table CT comprises a number of rows equal to the overall number of commercials stored in the advertising database ADB. Accordingly, by assuming that the advertising database ADB stores n different commercials, the commercial table CT preferably has n rows.

For instance, the first row of the commercial table CT comprises an identifier Com-id1 identifying a first commercial and an information V1 indicative of the value of the first commercial. Further, the first row may comprise additional information regarding the first commercial, such as for instance the duration of the first commercial, the target users of the first commercials, the format (audio, video, text, etc.) of the first commercial, etc. The additional information are indicated in FIG. 5 with the reference name ComInfo-1. The other rows of the commercial table CT are substantially identical to the first row described above, therefore a detailed description will not be repeated.

Accordingly, during the sub-step 83, the advertising delivery module ADM preferably selects the k commercials to be inserted in the advertising block Ai among the n commercials listed in the commercial table CT. The k commercials are preferably chosen so that the above conditions i) and ii) are fulfilled.

According to preferred embodiments of the present invention, the advertising delivery module ADM preferably selects the k commercials by taking into account also other information, such as the content type of the content Ci. For instance, if the content Ci is a football match, the advertising delivery module ADM may select among the n commercials only commercials relative to sport products.

Further, preferably, the k commercials are selected so that their format is compliant with the features of the second terminal Ty, so that they can be played by the terminal Ty. For instance, since it has been assumed that the second terminal Ty is the user's mobile phone, the k commercials may be in audio format, in text format, or in video format.

Then, preferably, during a sub-step 84 the advertising delivery module ADM preferably inserts the acknowledge request message ARM in the advertising block Ai.

Preferably, the acknowledge request message ARM is inserted in the advertising block Ai so that the user can known its entire content only after consuming all the k commercials.

For instance, if the acknowledge request message ARM is an alphanumeric code, the alphanumeric code may be inserted at the end of the last commercial of the advertising block Ai. Preferably, the alphanumeric code may be distributed in the k commercials of the advertising block Ai. For instance, if the k commercials are in video format, one or more characters of the alphanumeric code may be overwritten to each of the k commercials. Otherwise, if the k commercials are in audio format, one or more characters of the alphanumeric code can be pronounced between two consecutive commercials.

For instance, if the acknowledge request message ARM is a question regarding one of the k commercials of the advertising block Ai, the question may be inserted (preferably with the same format of the k commercials) at the end of the last commercial of the advertising block Ai.

Further, preferably, during the sub-step 84 the advertising delivery module ADM may also insert in the advertising block Ai instructions explaining to the user how to reply to the acknowledge request message ARM by means of an acknowledge message AM.

Preferably, such instructions comprise a description of how to correctly determine the content of the acknowledge message AM. For instance, in case the acknowledge request message ARM is an alphanumeric code, the instructions may explain that at the end (or during) the k commercials, an alphanumeric code of a given number of characters will be displayed (or pronounced), that the user will have to note the alphanumeric code down while consuming the k commercials, and that finally the user will have to send an acknowledge message AM including the noted alphanumeric code to the content provider. Alternatively, in case the acknowledge request message ARM is a question regarding one of the k commercials, the instructions may explain that at the end of the k commercials, a question on one of the k commercials will be displayed (or pronounced), and that the user will have to send to the content provider an acknowledge message AM including the answer to such a question.

Further, preferably, the instructions comprise an explanation of how the user may send the acknowledge message AM to the content provider. For instance, the acknowledge message AM may be sent by an SMS or by calling a given telephone number or by writing an e-mail to a given e-mail address, etc.

Preferably, the instructions are inserted in the advertising block Ai before the k commercials and before the acknowledge request message ARM. This allows the user to know from the beginning of the first commercial how to behave for correctly replying to the acknowledge request message ARM.

Optionally, the second terminal Ty is provided with a “rewind” function, so that the user may consume the commercial more than once. This advantageously allows to user to consume the k commercials until he has all the information allowing him to correctly reply to the acknowledge request message ARM, i.e. to determine the correct content of the acknowledge message AM.

Preferably, during the sub-step 85, the advertising delivery module ADM generates an identifier Ai-id univocally identifying the delivery of the advertising block Ai to the second terminal Ty.

Then, during a successive sub-step 86, the sponsorship manager SM preferably accesses a user table UT stored in the user database UDB.

In particular, by referring to FIG. 6, which shows the user table UT according to a preferred embodiment of the present invention, the sponsorship manager SM preferably inserts in the user table UT a row comprising:
a user identifier Uid identifying the user of the second terminal Ty. Preferably, the sponsorship manager SM retrieves the user identifier Uid from a database (not shown in the drawings) of the content provider, which stores the identifiers of all the users who subscribed the content-on-demand service. If the content provider is also a telephone service provider, the user identifier Uid may be advantageously retrieved from a database (not shown in the drawings) which stores all the telephone users;
the identifier Ai-id univocally identifying the delivery of the advertising block Ai to the second terminal Ty;
the expected acknowledge message EAM; and
the maximum delay Tmax.

According to preferred embodiments of the present invention, the sponsorship manager SM uses the information included in the user table UT for checking whether the user has really consumed the k commercials included in the advertising block Ai, as it will be described in detail herein after by referring to FIG. 4.

FIG. 4 is a flow chart showing in further detail step 10, wherein the sponsorship manager SM checks whether the user has really consumed the k commercials of the advertising block Ai by means of the second terminal Ty.

Preferably, after step 9, which ends when the second terminal Ty receives either the advertising block Ai or a link to the advertising block Ai, for a period equal to the maximum delay Tmax, the sponsorship manager SM checks whether the acknowledge message AM associated to the user identifier Uid and to the identifier Ai-id of the delivery of the advertising block Ai is received by the content provider.

In particular, during a first sub-step 100 the sponsorship manager SM checks whether the maximum delay Tmax has already expired. In the negative, the sponsorship manager SM performs a sub-step 101, wherein it checks whether the acknowledge message AM is being received. In the negative, the sponsorship manager may optionally periodically send a reminder to the second terminal Ty every Tr seconds (step 102), for reminding the user that if he will not consumed the k commercials before the maximum delay Tmax, he will be charged with the full price of the content Ci.

When, during the sub-step 101, the sponsorship manager SM detects that the acknowledge message AM is being received, it preferably retrieves the expected acknowledge message EAM from the user table UT, and it compares the content of the received acknowledge message AM and the content of the expected acknowledge message EAM (sub-step 103).

If the content of the received acknowledge message AM is equal to the content of the expected acknowledge message EAM, the sponsorship manager SM preferably determines that the user has actually consumed the k commercials, since he has been able to answer correctly to the acknowledge request message ARM. Therefore, preferably, in this case the sponsorship manager SM performs the above step 11, i.e. it instructs the billing module BM to charge the user with the reduced price of the content Ci. The sponsorship manager SM then preferably deletes the row shown in FIG. 6 from the user table UT.

Otherwise, if the sponsorship manager SM does not receive any acknowledge message AM within the maximum delay Tmax, or if during sub-step 103 the sponsorship manager SM determines that the content of the received acknowledge message AM is different from the content of the expected acknowledge message EAM, the sponsorship manager SM preferably determines that the user has not consumed the k commercials. Accordingly, preferably, in this case the sponsorship manager SM performs the above step 12, i.e. it instructs the billing module BM to charge the user with the full price of the content Ci. The sponsorship manager SM then preferably deletes the row shown in FIG. 6 from the user table UT.

Preferably, when during sub-step 103 the sponsorship manager SM determines that the content of the received acknowledge message AM is different from the content of the expected acknowledge message EAM, the sponsorship manager SM may send to the second terminal Ty a message informing the user that the content of the acknowledge message AM is not correct, and asking the user to check the acknowledge request message ARM (possibly by viewing again the commercials of the advertising block Ai) and to retransmit the acknowledge message AM. Preferably, the sponsorship manager SM may allow the user to transmit the acknowledge message AM with a wrong content for predefined number of times (e.g. three) before deciding to perform step 12 (i.e. charging the user with the full price).

Therefore, advantageously, the user may enjoy the purchased content Ci without any commercial break, and at the same time the content provider may check whether the user has actually consumed the k commercials.

Indeed, the user may receive the advertising block Ai (or a link to the advertising block Ai) on its second terminal Ty, which may also coincide with the first terminal Tx through which he enjoys the content Ci, and he may decide to consume the commercials in a further time period separated from the time period during which he enjoys the content Ci (provided that such a further time period expires before the end of the maximum delay Tmax). Therefore, for instance, the user may firstly enjoy the content Ci without interruptions, and then consume the commercials.

Advantageously, thanks to the fact that the advertising block Ai comprises the acknowledge request message ARM, to which the user can correctly reply only by entirely consuming the k commercials, the content provider may check that the user has actually “consumed” the k commercials within the maximum delay Tmax by checking whether an acknowledge message AM is received before Tmax expires, and by checking whether the content of the acknowledge message is correct by comparing it with the expected acknowledge message stored in the user table.

In the previous description, it has been assumed that the commercials are actually delivered to the second terminal Ty of the user.

However, according to other embodiments not shown in the drawings, when the sponsorship manager SM determines (see step 2 of the flow chart of FIG. 2) that the user wishes to pay a reduced price for the content Ci, the advertising delivery module ADM may send to the second terminal Ty an advertising block including k identifiers of k commercials and an acknowledge request message requesting the user to perform the following operations:
looking e.g. in a newspaper for the commercials identified by the k identifiers included in the advertising block; and
sending to the content provider an acknowledge message including a proof that the commercials have been viewed.

For instance, the commercials printed in the newspaper could comprise a bidimensional bar code. Accordingly, the user could be requested to take a picture of such bidimensional codes with the digital camera of its mobile phone, and send the pictures to the content provider. The sponsorship manager SM may then check whether the user has viewed the k commercials by comparing the bar codes reproduced in the received pictures with k expected bar codes.

1: Method of providing a content-on-demand service to a user by means of a communication network, wherein the method comprises:
a) transmitting a content to a first terminal of said user;
b) generating an acknowledge request message and an expected acknowledge message;
c) generating an advertising block including k commercials and said acknowledge request message in such a way that said user is able to answer to said acknowledge request message only after consuming said k commercials, wherein k is an integer number equal to or higher than 1;
d) transmitting said advertising block to a second terminal of said user;
e) listening for an acknowledge message from said second terminal; and
f) determining whether said received acknowledge message corresponds to said expected acknowledge message.

2: The method according to claim 1, wherein it further comprises charging said user with a reduced price for said content, if during said step f) it is determined that said received acknowledge message corresponds to said expected acknowledge message.

3: The method according to claim 1, wherein it further comprises, before said step d), a step of receiving from said user an information indicating whether said second terminal and said first terminal are a same terminal or different terminals.

4: The method according to claim 1, wherein it further comprises, after said step d), a step of consuming said k commercials by means of said second terminal during a given time period, said given time period being not superimposed with a further time period in which said user enjoys said content by means of said first terminal.

5: The method according to claim 1, wherein it further comprises, before said step e), a step of determining a maximum delay Tmax within which said user has to consume said k commercials.

6: The method according to claim 5, wherein said step e) is performed until said maximum delay Tmax expires.

7: The method according to claim 6, wherein said method further comprises a step of, if during said step e) said acknowledge message is not received before said maximum delay Tmax expires, charging said user with a full price of said content.

8: The method according to claim 1, wherein said step c) comprises a step of selecting said k commercials such that an overall value of said k commercials is about equal to a difference between said full price and said reduced price.

9: The method according to claim 1, wherein said step c) comprises a step of selecting said k commercials according to a content type of said content.

10: The method according to claim 1, wherein it further comprises, after said step c), a step of sending to said second terminal a link to said advertising block, said step d) being triggered by said user by selecting said link on said second terminal.

11: The method according to claim 1, wherein said step d) further comprises a step of deactivating at least one of a “skip” command and a “fast forward” command at said second terminal.

12: The method according to claim 1, wherein said step d) further comprises a step of keeping a “rewind” command active at said second terminal.

13: The method according to claim 1, wherein, during said step b), said acknowledge request message is generated in the form of an alphanumeric code, and said expected acknowledge message is also generated in the form of said alphanumeric code.

14: The method according to claim 1, wherein said step c) comprises distributing said acknowledge request message in said k commercials.

15: The method according to claim 1, wherein said step c) comprises a step of inserting in said advertising block instructions explaining to said user how to reply to said acknowledge request message by means of said acknowledge message.

16: The method according to claim 15, wherein said step c) comprises a step of inserting in said instructions a description of how to determine a content of said acknowledge message according to a content of said acknowledge request message.

17: The method according to claim 15, wherein said step c) comprises a step of inserting in said instructions a description of how to transmit said acknowledge message to a provider of said content-on-demand service.

18: The method according to claim 1, wherein it further comprises, if said acknowledge message is received and said acknowledge message does not correspond to said expected acknowledge message, a step of sending to said second terminal a message which informs said user that said acknowledge message is not correct, and which asks said user to check said acknowledge request message and to retransmit said acknowledge message.

19: A content-on-demand system for providing a content-on-demand service to a user by means of a communication network, said content-on-demand system comprising:
a content delivery module configured to transmit a content to a first terminal of said user;
a sponsorship manager configured to generate an acknowledge request message and an expected acknowledge message; and
an advertising delivery module configured to be activated by said sponsorship manager for:
generating an advertising block including k commercials and said acknowledge request message in such a way that said user is able to answer to said acknowledge request message only after consuming said k commercials, wherein k is an integer number equal to or higher than 1; and
transmitting said advertising block to a second terminal of said user, said sponsorship manager further being configured to:
listen for an acknowledge message from said second terminal); and
determining whether said received acknowledge message corresponds to said expected acknowledge message.

20: The content-on-demand system according to claim 19, wherein it further comprises a billing module, said sponsorship manager being further configured to instruct said billing module to charge said user with a reduced price of said content, if it determines that said received acknowledge message corresponds to said expected acknowledge message.

21: The content-on-demand system according to claim 19, wherein said sponsorship manager is further configured to determine a maximum delay Tmax within which said user has to consume said k commercials.

22: The content-on-demand system according to claim 21, wherein said sponsorship manager is further configured to listen for said acknowledge message from said second terminal until said maximum delay Tmax expires.

23: The content-on-demand system according to claim 22, wherein said sponsorship manager is further configured to instruct said billing module to charge said user with a full price, if said acknowledge message is not received before said maximum delay Tmax expires.

24: The content-on-demand system according to claim 23, wherein said advertising delivery module is further configured to select said k commercials such that an overall value of said k commercials is about equal to a difference between said full price and said reduced price.

25: The content-on-demand system according to claim 19, wherein said advertising delivery module is further configured to select said k commercials according to a content type of said content.

26: The content-on-demand system according to claim 19, wherein said sponsorship manager is further configured to generate said acknowledge request message in the form of an alphanumeric code, and to generate also said expected acknowledge message in the form of said alphanumeric code.

27: The content-on-demand system according to claim 19, wherein said advertising delivery module is further configured to distribute said acknowledge request message in said k commercials.

28: The content-on-demand system according to claim 19, wherein said advertising delivery module is further configured to insert in said advertising block instructions explaining to said user how to reply to said acknowledge request message by means of said acknowledge message.

29: The content-on-demand system according to claim 19, wherein said sponsorship manager is further configured to, if said acknowledge message is received and said acknowledge message does not correspond to said expected acknowledge message, send to said second terminal a message which informs said user that said acknowledge message is not correct, and which asks said user to check said acknowledge request message and to retransmit said acknowledge message.
